(19) United States
(12) Patent Application Publication
(10) Pub. No.: US 2026/0023151 A1
(43) Pub. Date: Jan. 22, 2026

(54) THREE-DIMENSIONAL TRACKING OF A TRANSMITTER WITHIN A VOLUME

(71) Applicant: GM GLOBAL TECHNOLOGY OPERATIONS LLC, Detroit, MI (US)

(72) Inventors: Zijun Han, Madison Heights, MI (US); Jinzhu Chen, Troy, MI (US); Chuan Li, Troy, MI (US); Fan Bai, Ann Arbor, MI (US)

(73) Assignee: GM GLOBAL TECHNOLOGY OPERATIONS LLC, Detroit, MI (US)

(21) Appl. No.: 18/778,064

(22) Filed: Jul. 19, 2024

(51) Int. Cl. G01S 5/02; G01S 5/04; G01S 5/14

(52) U.S. Cl. CPC G01S 5/0268; G01S 5/0244; G01S 5/04; G01S 5/145

(57) ABSTRACT

A system includes a plurality of angle-of-arrival receivers, a plurality of time-of-arrival receivers, and a processing circuit. The plurality of angle-of-arrival receivers is operational to measure a plurality of directions between a transmitter and the plurality of angle-of-arrival receivers. The transmitter moves within a volume. The plurality of time-of-arrival receivers is operational to measure a plurality of distances between the transmitter and the plurality of time-of-arrival receivers. The processing circuit is coupled to the plurality of angle-of-arrival receivers and the plurality of time-of-arrival receivers. The processing circuit is operational to determine a location of the transmitter in three dimensions within the volume based on the plurality of directions and the plurality of distances, and report the location of the transmitter to additional circuitry.

### INTRODUCTION

The present disclosure relates to a system and a method for three-dimensional tracking of a transmitter within a volume.

Existing vehicle internal phone location systems experience accuracy challenges in three-dimensional spaces. Communication latency and sensor dependence cause inefficient localization solutions in tracking moving phones. Furthermore, angle-of-arrival techniques have issues where viewing angle restrictions are present.

Accordingly, those skilled in the art continue with research and development efforts in the field of tracking a transmitter, such as a mobile phone, in an interior of a vehicle.

### SUMMARY

A system is provided herein. The system includes a plurality of angle-of-arrival receivers, a plurality of time-of-arrival receivers, and a processing circuit. The plurality of angle-of-arrival receivers is operational to measure a plurality of directions between a transmitter and the plurality of angle-of-arrival receivers. The transmitter moves within a volume. The plurality of time-of-arrival receivers is operational to measure a plurality of distances between the transmitter and the plurality of time-of-arrival receivers. The processing circuit is coupled to the plurality of angle-of-arrival receivers and the plurality of time-of-arrival receivers. The processing circuit is operational to determine a location of the transmitter in three dimensions within the volume based on the plurality of directions and the plurality of distances, and report the location of the transmitter to additional circuitry.

In one or more embodiments of the system, to determine the location of the transmitter, the processing circuit is further operational to perform a time-dependent weighted linear least squares operation on the plurality of directions and the plurality of distances.

In one or more embodiments of the system, the time-dependent weighted linear least squares operation includes a trustworthiness analysis on a plurality of sequential measurements of the plurality of directions and the plurality of distances.

In one or more embodiments of the system, the trustworthiness analysis includes a spatial consistency analysis that determines a plurality of deviations of the plurality of sequential measurements from a global estimate, a temporal consistency analysis that calculates a plurality of standard deviations of the plurality of sequential measurements over time, and determines a consistency based on the plurality of deviations and the plurality of standard deviations.

In one or more embodiments of the system, the time-dependent weighted linear least squares operation includes calculate a plurality of weights in response to a plurality of measurement times, a plurality of localization timestamps, and the consistency, and construction of a weighted matrix based on the plurality of weights.

In one or more embodiments of the system, to determine the location of the transmitter, the processing circuit is further operational to perform a two-stage localization operation on the plurality of directions and the plurality of distances.

In one or more embodiments of the system, a first stage of the two-stage localization operation includes to determine a plurality of pseudo locations of the transmitter within the volume based on the plurality of distances.

In one or more embodiments of the system, a second stage of the two-stage localization operation includes to determine one of the plurality of pseudo locations as the location of the transmitter based on the plurality of directions.

In one or more embodiments of the system, the second stage of the two-stage localization operation includes to remove one or more out-of-view pseudo locations of the plurality of pseudo locations that is hidden from one or more of the plurality of angle-of-arrival receivers prior to the determination of the location.

In one or more embodiments of the system, the transmitter is a mobile phone operational to transmit a signal detectable by the plurality of angle-of-arrival receivers and the plurality of time-of-arrival receivers.

A method for three-dimensional tracking of a transmitter within a volume is provided herein. The method includes measuring a plurality of directions between the transmitter and a plurality of angle-of-arrival receivers. The transmitter moves within the volume. The method includes measuring a plurality of distances between the transmitter and a plurality of time-of-arrival receivers, determining with a processing circuit a location of the transmitter in three dimensions within the volume based on the plurality of directions and the plurality of distances, and reporting the location of the transmitter from the processing circuit to additional circuitry.

In one or more embodiments of the method, the determination of the location of the transmitter includes performing a time-dependent weighted linear least squares operation on the plurality of directions and the plurality of distances.

In one or more embodiments of the method, the time-dependent weighted linear least squares operation includes analyzing a trustworthiness on a plurality of sequential measurements of the plurality of directions and the plurality of distances.

In one or more embodiments of the method, the analyzing of the trustworthiness includes analyzing a spatial consistency that determines a plurality of deviations of the plurality of sequential measurements from a global estimate, analyzing a temporal consistency that calculates a plurality of standard deviations of the plurality of sequential measurements over time, and determining a consistency based on the plurality of deviations and the plurality of standard deviations.

In one or more embodiments of the method, the time-dependent weighted linear least squares operation includes calculating a plurality of weights in response to a plurality of measurement times, a plurality of localization timestamps, and the consistency, and constructing of a weighted matrix based on the plurality of weights.

In one or more embodiments of the method, the determining of the location of the transmitter includes performing a two-stage localization operation on the plurality of directions and the plurality of distances.

In one or more embodiments of the method, a first stage of the two-stage localization operation includes determining a plurality of pseudo locations of the transmitter within the volume based on the plurality of distances.

In one or more embodiments of the method, a second stage of the two-stage localization operation includes determining one of the plurality of pseudo locations as the location of the transmitter based on the plurality of directions.

In one or more embodiments of the method, the second stage of the two-stage localization operation includes removing one or more out-of-view pseudo locations of the plurality of pseudo locations that is hidden from one or more of the plurality of angle-of-arrival receivers prior to the determination of the location.

A vehicle is provided herein. The vehicle includes a cabin, a plurality of angle-of-arrival receivers, a plurality of time-of-arrival receivers, and a processing circuit. The cabin defines a volume. The volume is sized to hold one or more occupants and a transmitter. The one or more occupants are operational to move the transmitter within the volume. The plurality of angle-of-arrival receivers is disposed in the cabin and is operational to measure a plurality of directions between the transmitter and the plurality of angle-of-arrival receivers. The plurality of time-of-arrival receivers is disposed in the cabin and is operational to measure a plurality of distances between the transmitter and the plurality of time-of-arrival receivers. The processing circuit is coupled to the plurality of angle-of-arrival receivers and the plurality of time-of-arrival receivers. The processing circuit is operational to determine a location of the transmitter in three dimensions within the volume based on the plurality of directions and the plurality of distances, and report the location of the transmitter to additional circuitry.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram illustrating a context of a vehicle.

FIG. 2 is a schematic perspective diagram of a time-of-arrival measurement in accordance with one or more exemplary embodiments.

FIG. 3 is a schematic perspective diagram of an angle-of-arrival measurement in accordance with one or more exemplary embodiments.

FIG. 4 is a graph of valid ranges of angle-of-arrival receivers in accordance with one or more exemplary embodiments.

FIG. 5 is a schematic functional block diagram of a time delay-aware weighted sensor fusion technique in accordance with one or more exemplary embodiments.

FIG. 6 is a graph of a time-delay association for moving objects in accordance with one or more exemplary embodiments.

FIG. 7 is a schematic perspective diagram of a localization in accordance with one or more exemplary embodiments.

FIG. 8 is a schematic functional block diagram of a two-stage time-of-arrival/angle-of-arrival localization technique in accordance with one or more exemplary embodiments.

FIG. 9 is a schematic plan diagram of results for a two-state time-of-arrival/angle-of-arrival localization technique in accordance with one or more exemplary embodiments.

FIG. 10 is a schematic plan diagram of an out-of-view transmitter in accordance with one or more exemplary embodiments.

FIG. 11 is a schematic diagram of a sensor fusion neural network in accordance with one or more exemplary embodiments.

FIG. 12 is a schematic diagram of a neural network architecture design in accordance with one or more exemplary embodiment.

### DETAILED DESCRIPTION

Embodiments of the disclosure provide a hybrid time-of-arrival (TOA)/angle-of-arrival (AOA) three-dimensional localization system for vehicle internal smartphone tracking through ultra-wideband (UWB) sensors. To reduce the communication latency and sensor dependency, the localization system incorporates fewer multi-antenna sensors than in existing designs. Regarding viewing range restriction and precision issues, at least one of two techniques are provided in various designs of the localization system. A first technique considers a signal receiving delay and improves the localization accuracy through a weighted strategy. A second technique focuses on balancing contributions between time-of-arrival and angle-of-arrival in sensor fusion.

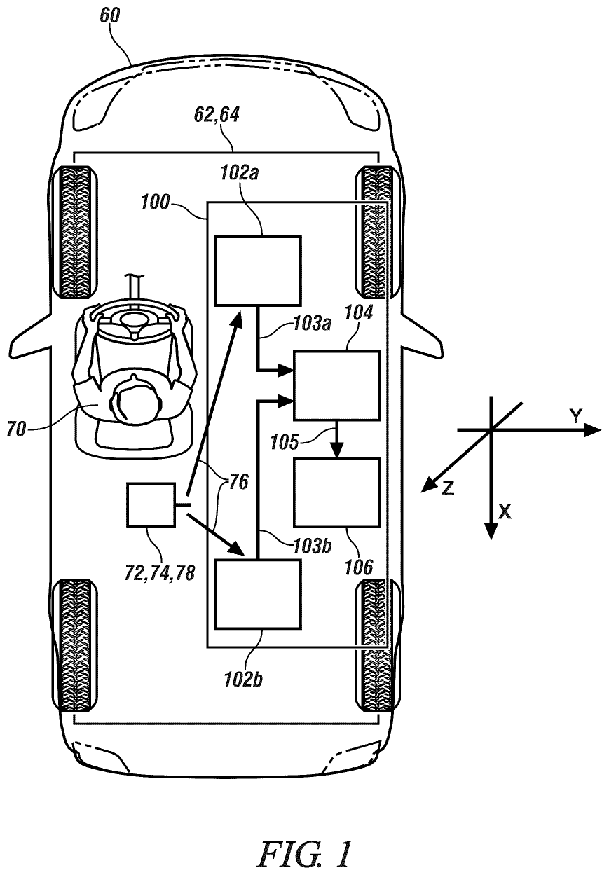

Referring to FIG. 1, a schematic diagram illustrating a context of a vehicle 60. The vehicle 60 generally includes a cabin 62 that defines an interior volume 64. The cabin 62 is sized to hold one or more occupants 70, one or more mobile phones 72 (e.g., smartphones) and at least part of a system 100. The mobile phones 72 (e.g., transmitters 74) may transmit wireless signals 76 that are received by the system 100.

For the purposes of explanation, a front to rear direction of the vehicle 60 may define a positive X direction. A left to right side direction of the vehicle 60 (as seen looking down at a top of the vehicle 60) may define a positive Y direction. A bottom to top direction of the vehicle 60 (as seen looking a side of the vehicle 60) generally defines a positive Z direction. The X direction, the Y direction, and the Z direction may be orthogonal to each other.

The system 100 implements a localization system. The system 100 generally includes multiple (e.g., two) sensor anchors 102a-102b, a processing circuit 104, and additional circuitry 106. In various embodiments, a front sensor anchor 102a is placed within the volume 64 in or near a front console facing backwards (e.g., in the positive X direction). A mounting location [x, y, z] and an orientation [orientation-azimuth, orientation-elevation] of the sensors in the front sensor anchor 102a may be [0, 0, 0] in centimeters and [0, 0] in degrees. A rear sensor anchor 102b is placed within the volume 64 near a back window facing forward (e.g., in the negative X direction). A mounting location [x, y, z] and an orientation [orientation-azimuth, orientation-elevation] of the sensors in the rear anchor 102b may be [150, 0, 0] in centimeters and [180, 0] in degrees. Other placements and/or other orientations may be implemented to meet the design criteria of a particular application.

The vehicle 60 may include, but is not limited to, mobile objects such as a passenger vehicle, a truck, an autonomous vehicle, a gas-powered vehicle, an electric-powered vehicle, a hybrid vehicle, a motorcycle, a boat, a farm vehicle, a train and/or an aircraft. In some embodiments, the vehicle 60 may include stationary objects such as buildings. Other types of vehicles 60 may be implemented to meet the design criteria of a particular application.

The sensor anchors 102a-102b each implement multiple (e.g., three) antennas of TOA and AOA sensors. The sensor anchors 102a-102b are operational to determine a location 78 of the mobile phone 72/transmitter 74. In various embodiments, the TOA sensors and/or the AOA sensors may be implemented as ultra-wideband sensors. Sensor data signals 103a-103b may be conveyed to the processing circuit 104.

The processing circuit 104 implements one or more digital circuits. The processing circuit 104 is operational to present the current location 78 of the transmitter 74 to the additional circuitry 106. The processing circuit 104 may receive directional data and angular data from the sensor anchors 102a-102b via the sensor data signals 103a-103b. Location data determined by the processing circuit 104 may be transferred to the additional circuitry 106 via a location signal 105.

In various embodiments, the processing circuit 104 is implemented as at least one microcontroller. The at least one microcontroller may include one or more processors, each of which may be embodied as a separate processor, an application specific integrated circuit (ASIC), a field programmable gate array (FPGA), or a dedicated electronic control unit. The at least one microcontroller may be an electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present method may be recorded (or stored) in the memory and executed as set forth herein. The executable instructions may be a series of instructions employed to run applications on the at least one microcontroller (either in the foreground or background). The at least one microcontroller may receive commands and information, in the form of one or more input signals from various controls or components and communicate instructions to the other electronic components.

The additional circuitry 106 implements more digital circuitry. The additional circuitry 106 is operational to perform a variety of operations on the location information received from the processing circuit 104. For example, the additional circuitry 106 may determine if an occupant 70 is in a back seat of the vehicle 60 based upon determining a location 78 of a mobile phone 72 proximate the back seat. Other use cases may be implemented by the additional circuitry 106 to meet the design criteria of a particular application.

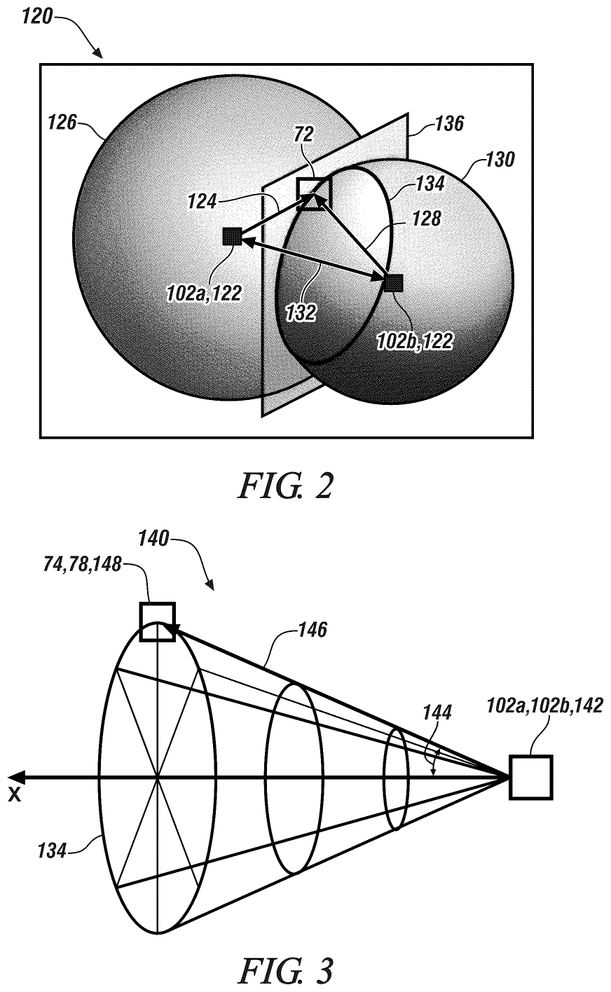

Referring to FIG. 2 with reference back to FIG. 1, a schematic perspective diagram 120 of an example time-of-arrival measurement is shown in accordance with one or more exemplary embodiments. TOA measurements generally provide accurate distance estimates between the transmitter and the receiver. For AOA measurements, directional information about the signal from the transmitter arriving at the receiver. By using multiple antennas or antenna arrays, the receiver may estimate the angle of arrival of the signal. In hybrid TOA/AOA localization, by combining both distance and angle measurements, the hybrid tracking system 100 localizes and tracks the transmitter 74 in both distance and angle dimensions, obtaining the final location in three-dimensional space with a few anchor sensors 102a-102b.

The TOA measurement uses a first time of arrival of the signal 76 and the front sensor anchor 102a (e.g., a TOA sensor 122) to calculate a first distance 124 (e.g., a radius of a first sphere 126). A second time of arrival of the signal 76 and the rear sensor anchor 102b (e.g., another TOA sensor 122) is used to calculate a second distance 128 (e.g., a radius of a second sphere 130). Knowing a separation 132 between the TOA sensors 122, a transmitting device (e.g., the mobile phone 72) of the signal 76 may be located at multiple pseudo locations (or points) along a circle 134 in a plane 136 where the first sphere 126 and the second sphere 130 intersect.

Referring to FIG. 3 with reference back to FIG. 2, a schematic perspective diagram 140 of an example angle-of-arrival measurement is shown in accordance with one or more exemplary embodiments. The AOA measurement uses one or more of the sensor anchors 102a-102b (e.g., AOA sensors 142) to measure one or more angles 144 of arrival of the signal 76. Each angle 144 generally define a direction 146 toward the transmitter 74. Where coupled with the circle 134 from the TOA measurements (FIG. 2), the location 78 of the transmitter 74 may be refined to a specific pseudo location 148 where the direction 146 intersects the circle 134.

In some situations, limitations on the coverage of angles 144 from which the signals 76 may be accurately measured may limit an ability of the AOA sensor 142 to accurately determine the angles of signal arrival within certain spatial regions. In addition, angle of arrival measurements are generally considered to be less accurate than time of arrival measurements. Furthermore, independent sensors 122 and 142 generally do not simultaneously provide measurements due to the communication constraints. The measurements provided by the sensor 122 and 142 may not be synchronized or aligned in time, leading to potential discrepancies or gaps in the data.

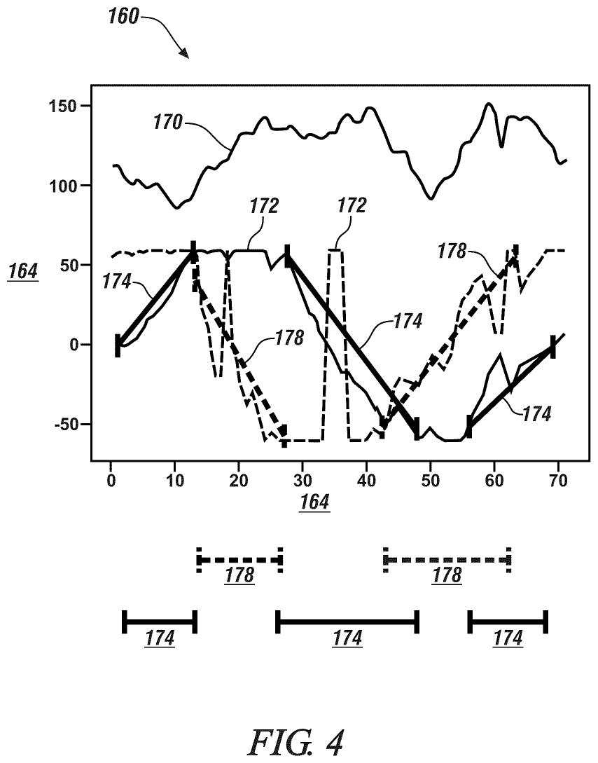

Referring to FIG. 4, a graph of example valid ranges of AOA receivers is shown in accordance with one or more exemplary embodiments. The graph 160 is illustrated as an example in two-dimensions. The graph 160 generally has an X-axis 162 in units of degrees, and a Y-axis 164 in units of feet.

A curve 170 illustrates an example distance from the transmitter 74. A curve 172 illustrates an example measurement of the angle of arrival as detected by the AOA sensor at the front sensor anchor 102a. AOA sensor at the front sensor anchor 102a may have valid measurement ranges 174 over several angle bands (or ranges). A curve 182 illustrates an example measurement of the angle of arrival as detected by the AOA sensor at the rear sensor anchor 102b. AOA sensor at the rear sensor anchor 102b may have valid measurement ranges 178 over several angle bands (or ranges). Therefore, the sensor anchors 102a-102b may continuously cover the angles of arrival between zero degrees and 70 degrees.

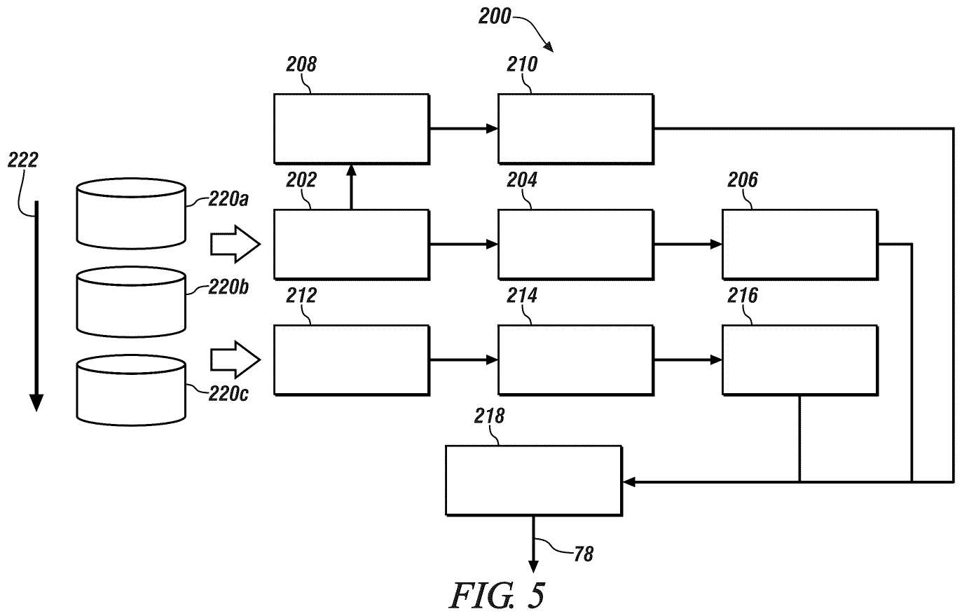

Referring to FIG. 5, a schematic functional block diagram of an example time delay-aware weighted sensor fusion technique is shown in accordance with one or more exemplary embodiments. The time delay-aware weighted sensor fusion technique 200 generally includes steps (or blocks) 202 to 218 as illustrated. Inputs to the time delay-aware weighted sensor fusion technique 200 include sequential TOA/AOA measurements 220a-220c over multiple measurement times 222. The location 78 may be presented as an output of the time delay-aware weighted sensor fusion technique 200. The sequence of steps is shown as a representative example. Other step orders may be implemented to meet the criteria of a particular application. The time delay-aware weighted sensor fusion technique 200 may be implemented by the system 100.

In the step 202, data processing is performed on the sequential measurements 220a-220c. The processed measurements may be presented to the step 204 and the step 208. Sensor orientation mapping is performed in the step 204. In the step 206, the oriented measurement data is used to construct an AOA matrix. The AOA matrix is presented to the step 218.

In the step 208, a coordinate transform is performed on the processed measurements. The transformed measurements are used in the step 210 to construct a TOA matrix. The TOQ matrix is presented to the step 218.

In the step 212, a trustworthiness analysis is performed on the sequential measurements 220a-220c. A timing/delay association is performed in the step 214 on the data received from the step 212. The timing/delay association results are used to construct a weight matrix in the step 216. The weight matrix is presented to the step 218.

In the step 218, a weighted least squares operation is performed based on the TOA matrix from the step 210, the AO matrix from the step 206, and the weight matrix from the step 216. The weighted least squares operation generally produces the location 78.

An analysis of the sensor trustworthiness (e.g., measurements consistency, spatial consistency, time consistency) includes multiple calculations. A Chi-Square test measures a deviation of the local measurements from a global estimate. Lower deviation values suggest greater consistency and hence higher spatial consistency. The deviation values may be determined by equations 1-3 as follows:

$${Dev}_{s} ( j ) = \sqrt{\frac{1}{m} {\sum }_{j = 1}^{m} {( {L}_{j} - {L}_{0} )}^{2}} \qquad Eq . ( 1 )$$

Where Lⱼ is the observed local measurement from sensor j and is determined as follows:

$${L}_{j} = [ {x}_{j} , {y}_{j} , {z}_{j} ] = [ {x}_{j} + cos ( {θ}_{j} - {α}_{j} ) ( {d}_{j} ) , {y}_{j} + sin ( {θ}_{j} - {β}_{j} ) ( {d}_{j} ) , {z}_{j} + sin ( {θ}_{j}^{″} - {γ}_{j} ) ( {d}_{j} ) ] \qquad Eq . ( 2 )$$

Lₒ is the global estimate where:

$${L}_{o} = \frac{{\sum }_{j = 1}^{m} ( {L}_{j} )}{m} \qquad Eq . ( 3 )$$

Standard deviation: Calculate the standard deviation of the local measurements over time to check if the signals 76 behave in a predictable and stable manner over time. A lower standard deviation indicates greater temporal consistency and therefore higher trustworthiness. The standard deviation values may be determined by equation 4 as follows:

$${Dev}_{t} ( k ) = \sqrt{\frac{1}{n} {\sum }_{k = 1}^{n} {( {x}_{t} - \hat{x} )}^{2}} \qquad Eq . ( 4 )$$

Where xₜ is the measurement at time t;
\hat{x} is mean of the measurements; and
n is the total number of measurements.

Considering both spatial consistency and temporal consistency, the consistency, Cⱼ, is define as:

$${C}_{j} = \frac{1}{{Dev}_{s} ( j ) * {Dev}_{t} ( j )} \qquad Eq . ( 5 )$$

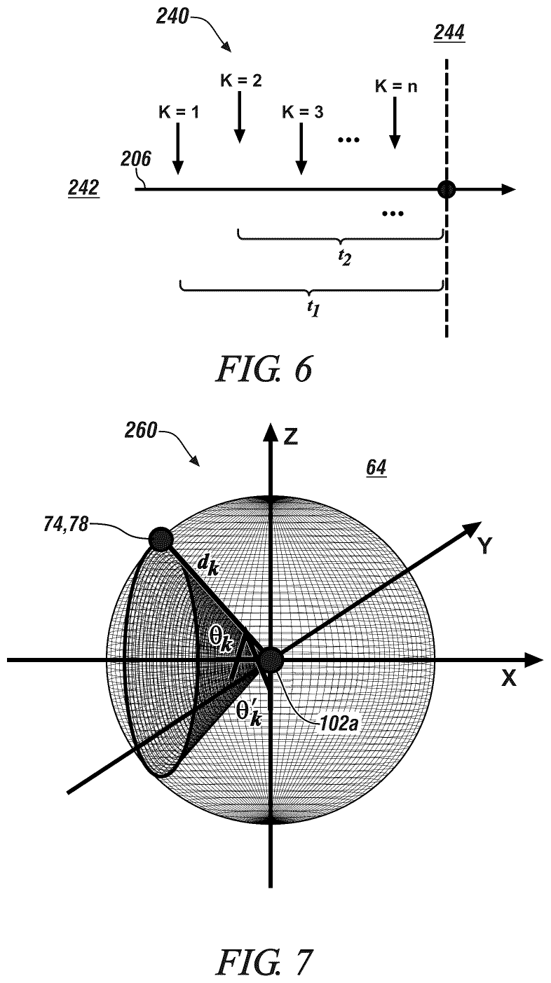

Referring to FIG. 6 with references back to FIG. 1, a graph of an example time-delay association for moving objects is shown in accordance with one or more exemplary embodiments. The graph 240 illustrates timestamps 242 advancing in time (e.g., left to right), and a location estimation 244.

To track the moving transmitter 74, closer measurements tend to be more accurate due to the signal delays (phase shifts).

The delay between measurements and the localization timestamps are denoted as δts=[δt₁, δt₂, . . . , δtₙ].

The weight, Wₖ, of TOA/AOA from for the kₜₕ received measurement from sensor q is as follows:

$${W}_{k} = \frac{δ {t}_{k} - max ( δ ts )}{max ( δ ts ) - min ( δ ts )} * {C}_{j} \qquad Eq . ( 6 )$$

Referring to FIG. 7, a schematic perspective diagram 260 of an example localization is shown in accordance with one or more exemplary embodiments. The diagram 260 illustrated the front sensor anchor 102a relative to a transmitter 74 at the location 78 in three-dimensional space (e.g., within the volume 64.

Consider a weighted linear least squares (LLS) matrix technique. Given the weight, Wₖ, of TOA/AOA from the kth received measurement from sensor q per equation 6 the weight matrix. W. is constructed with respect to each measurement as:

$$W = ( \begin{matrix}{w}_{1} & 0 & ⋯ & 0 \\ 0 & {w}_{2} & ⋯ & 0 \\ ⋮ & ⋮ & ⋱ & ⋮ \\ 0 & 0 & ⋯ & {w}_{n}\end{matrix} ) \qquad Eq . ( 7 )$$

Additionally, the hybrid TOA/AOA matrix may be defined as:

$$A = [ \begin{matrix}{A}_{1} \\ {A}_{2} \\ ⋯ \\ {A}_{n}\end{matrix} ] ; B = [ \begin{matrix}{B}_{1} \\ {B}_{2} \\ ⋯ \\ {B}_{n}\end{matrix} ] \qquad Eq . ( 8 )$$

$${A}_{k} = [ \begin{matrix}1 , & 0 , & 0 \\ 0 , & 1 , & 0 \\ 0 , & 0 , & 1 ,\end{matrix} ] ; {B}_{k} = [ \begin{matrix}{x}_{j} + cos ( {θ}_{k} - {α}_{j} ) ( {d}_{k} ) \\ {y}_{j} + sin ( {θ}_{k} - {β}_{j} ) ( {d}_{k} ) \\ {z}_{j} + sin ( {θ}_{k}^{′ ′ ′} - {γ}_{j} ( {d}_{k} )\end{matrix} ] \qquad Eq . ( 9 )$$

Where the kₜₕ measurement is observed from the jₜₕ sensor anchor 102a-102b, and:

$${W}_{k} = [ \begin{matrix}\frac{δ {t}_{k} - max ( δ ts )}{max ( δ ts ) - min ( δ ts )} * {C}_{j} , 0 , 0 \\ 0 , \frac{δ {t}_{k} - max ( δ ts )}{max ( δ ts ) - min ( δ ts )} * {C}_{j} , 0 \\ 0 , 0 , \frac{δ {t}_{k} - max ( δ ts )}{max ( δ ts ) - min ( δ ts )} * {C}_{j}\end{matrix} ] \qquad Eq . ( 10 )$$

The weighted linear least squares may be applied in the localization.

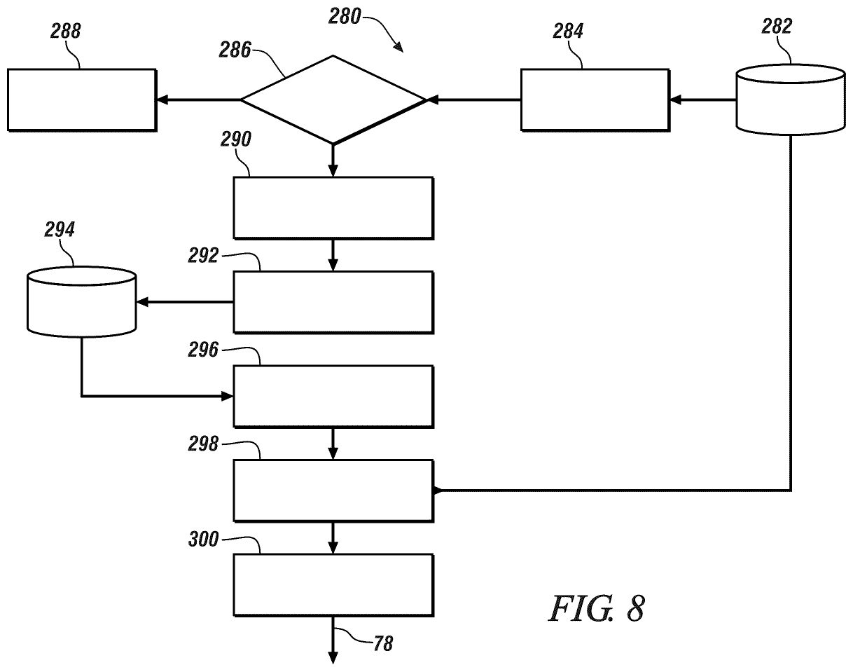

Referring to FIG. 8, a schematic functional block diagram of an example two-stage TOA/AOA localization technique is shown in accordance with one or more exemplary embodiments. The two-stage TOA/AOA localization technique 280 generally includes steps (or blocks) 282 to 300 as illustrated. Inputs to the two-stage TOA/AOA localization technique 280 include sequential TOA/AOA measurements. The location 78 may be presented as an output of the two-stage TOA/AOA localization technique 280. The sequence of steps is shown as a representative example. Other step orders may be implemented to meet the criteria of a particular application. The two-stage TOA/AOA localization technique 280 may be implemented by the system 100.

In the step 282, the TOA measurements may be made by the sensor anchors 102a-102b. The TOA measurements are presented to the step 284 and the step 298. The step 284 performs a dimension reduction on the TOA measurements. If an in-vehicle validation is not in progress, the two-stage TOA/AOA localization technique 280 stops in the step 288. If the in-vehicle validation is in progress, the two-stage localization TOA/AOA technique 280 continues with the step 290.

In the step 290, the AOA valid ranges are verified. A sensor selection is performed in the step 292. The selection is provided to the AOA sensor. In the step 294, the selected sensors produce the AOA measurements. The AOA measurements are provided to the step 296. A coordinate transform is performed in the step 296.

In the step 298, the TOA measurements and the transformed AOA measurements drive a hybrid TOA/AOA linear least squares (LLS) localization. The three-dimensional location 78 is output in the step 300.

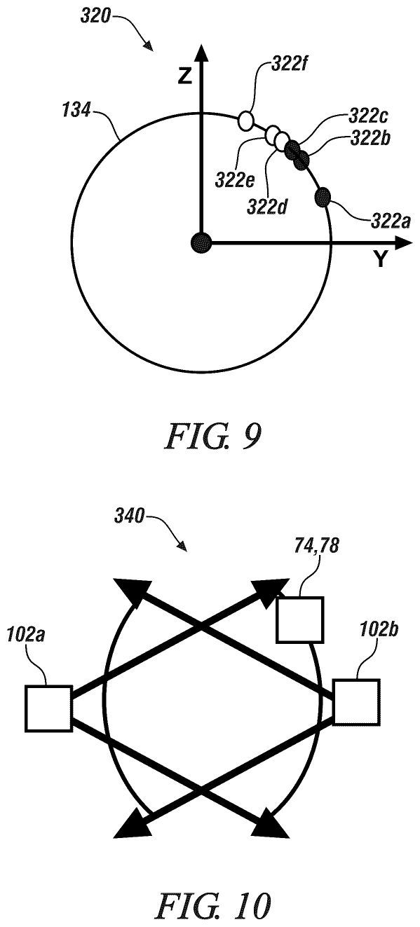

Referring to FIG. 9 with references back to FIG. 1, a schematic plan diagram 320 of an example results for a two-state TOA/AOA localization technique is shown in accordance with one or more exemplary embodiments. The diagram 320 illustrates a view as measured from one of the sensor anchors 102a-102b along the X direction. A first stage in the two-stage TOA/AOA localization is generally illustrated in FIG. 2. The first stage generally determines the circle 134 in the three-dimensional volume 64. Advantages of the two-stage localization over raw three-dimensional space searching include higher priority on accuracy and better (e.g., simpler) computation complexity.

The second stage in the two-stage TOA/AOA localization is generally illustrated in FIG. 3. A first AOA sensor may determine multiple pseudo locations 322a-322c. A second AOA sensor may determine multiple pseudo locations 322d-322f. Various techniques may be used in different embodiments to determine the location 78 (FIG. 1) among the pseudo locations 322a-322f.

In various embodiments, a dimension reduction may be applied for accurate one-stage localization. Assuming the sensor anchors 102a-102b are placed on a same line so that yᵢ=yⱼ and zᵢ=zⱼ, in the first step, the variable x may be removed through TOA measurements. The original TOA measurements formulas are reduced to:

$${( x - {x}_{i} )}^{2} + {( y - {y}_{i} )}^{2} + {( z - {z}_{i} )}^{2} = {( {d}_{i} )}^{2} \qquad Eq . ( 11 )$$

$${( x - {x}_{j} )}^{2} + {( y - {y}_{j} )}^{2} + {( z - {z}_{j} )}^{2} = {( {d}_{j} )}^{2} \qquad Eq . ( 12 )$$

Combining equations 11 and 12, the x coordinate of the transmitter 74 is:

$$x = \frac{{( {d}_{i} )}^{2} - {( {d}_{j} )}^{2} - {( {x}_{i} )}^{2} + {( {x}_{j} )}^{2}}{2 ( {x}_{j} - {x}_{i} )} \qquad Eq . ( 13 )$$

Referring to FIG. 10, a schematic plan diagram 340 of an example out-of-view transmitter is shown in accordance with one or more exemplary embodiments. AOA valid range verification may be performed to remove certain AOA data to avoid out-of-view faulty measurements of the location 78 of the transmitter 74. Due to the limitations on the coverage of angles from certain sensors, the out-of-view AOA data may be filtered out to improve the localization accuracy. In the example, the transmitter 74 is at a location 78 that is viewable by the front sensor anchor 102a but out of view for the rear sensor anchor 102b.

Sensor out-of-view verification may be provided as follows:

$${R}_{k} = \sqrt{{( {d}_{k} )}^{2} - {( x - {x}_{k} )}^{2}} \qquad Eq . ( 14 )$$

$$If arcsin ( \frac{R}{{θ}_{k}} ) > {θ}_{k} , tag {θ}_{k} and {θ}_{k}^{′} ,$$

reject the invalid measurement (mask mₖ=0), otherwise, accept the anchor AOA measurement (mask mₖ=1).

Computation complexity for the second stage of the hybrid TOA/AOA LLS localization technique may be reduced. After filtering the unreliable measurements by constructing a mask matrix with mₖ, the y, z coordinates of the transmitter 74 (e.g., the location L) may be estimated in the second stage through the assistance from AOA from valid measurements:

$$A = [ \begin{matrix}{m}_{i} , 0 \\ {m}_{j} , 0 \\ 0 , {m}_{i} \\ 0 , {m}_{j}\end{matrix} ] ; B = [ \begin{matrix}{y}_{i} + sin ( {θ}_{i} - {β}_{i} ) ( {d}_{i} ) \\ {y}_{j} + sin ( {θ}_{j} - {β}_{j} ) ( {d}_{j} ) \\ {z}_{i} + sin ( {θ}_{i}^{′ ′ ′} - {γ}_{i} ) ( {d}_{i} ) \\ {z}_{i} + sin ( {θ}_{j}^{′ ′ ′} - {γ}_{j} ) ( {d}_{j} )\end{matrix} ] \qquad Eq . ( 15 )$$

$$L = {A}^{- 1} B \qquad Eq . ( 16 )$$

The TOA/AOA localization basic symbols/equations are as follows. Multiple parameters are provided in Table I for several (e.g., four) timestamps.

TABLE I

| Time- | | Mounting | Measured | Azimuth | Elevation |
|---|---|---|---|---|---|
| stamp | Anchor | location | distance | AOA | AOA |
| 1 | Front Anchor | (x₁, y₁, z₁) | r₁ | θ₁ | θ′₁ |
| 2 | Rear Anchor | (x₂, y₂, z₂) | r₂ | θ₂ | θ′₂ |
| 3 | Front Anchor | (x₃, y₃, z₃) | r₃ | θ₃ | θ′₃ |
| 4 | Rear Anchor | (x₄, y₄, z₄) | r₄ | θ₄ | θ′₄ |

$$TOA = {( x - {x}_{1} )}^{2} + {( y - {y}_{1} )}^{2} + {( z - {z}_{1} )}^{2} = {r}_{1}^{2} \qquad Eq . ( 17 )$$

$${( x - {x}_{2} )}^{2} + {( y - {y}_{2} )}^{2} + {( z - {z}_{2} )}^{2} = {r}_{2}^{2}$$

$${( x - {x}_{3} )}^{2} + {( y - {y}_{3} )}^{2} + {( z - {z}_{3} )}^{2} = {r}_{3}^{2}$$

$${( x - {x}_{4} )}^{2} + {( y - {y}_{4} )}^{2} + {( z - {z}_{4} )}^{2} = {r}_{4}^{2}$$

$$TOA = ( y - {y}_{1} ) / ( x - {x}_{1} ) = tan ( {θ}_{1} ) \qquad Eq . ( 18 )$$

$$( y - {y}_{2} ) / ( x - {x}_{2} ) = tan ( {θ}_{2} )$$

$$( y - {y}_{3} ) / ( x - {x}_{3} ) = tan ( {θ}_{3} )$$

$$( y - {y}_{4} ) / ( x - {x}_{4} ) = tan ( {θ}_{4} )$$

$$( z - {z}_{1} ) / ( x - {x}_{1} ) = tan ( {θ}_{1}^{′} )$$

$$( z - {z}_{2} ) / ( x - {x}_{2} ) = tan ( {θ}_{2}^{′} )$$

$$( z - {z}_{3} ) / ( x - {x}_{3} ) = tan ( {θ}_{3}^{′} )$$

$$( z - {z}_{4} ) / ( x - {x}_{4} ) = tan ( {θ}_{4}^{′} )$$

Additional symbol definitions:

xⱼ, yⱼ, zⱼ: mounting location of the jₜₕ sensor.

αⱼ, βⱼ, γⱼ: mounting orientation of the jₜₕ sensor.

dₖ: the kₜₕ TOA measurement.

θₖ: the kₜₕ azimuth AOA measurement.

θ′ₖ the kₜₕ elevation AOA measurement.

L=[x, y, z]: the estimated location of the target.

A, B: the matrix of the parameter derived from the TOA and AOA measurements.

Aₖ, Bₖ: the LLS matrix from the kₜₕ measurement.

W: the weighted matrix derived from the trustworthy analysis in the weighted LLS approach.

Wₖ: the weighed matrix from the kₜₕ measurement.

Additional symbols in the two-stage LLS.

Rₖ: the distance between the center of the circle (derived from the first stage localization) and the kₜₕ sensor.

mₖ: the mask parameter for the jₜₕ sensor (mₖ=1: valid measurement; mₖ=0: invalid measurement).

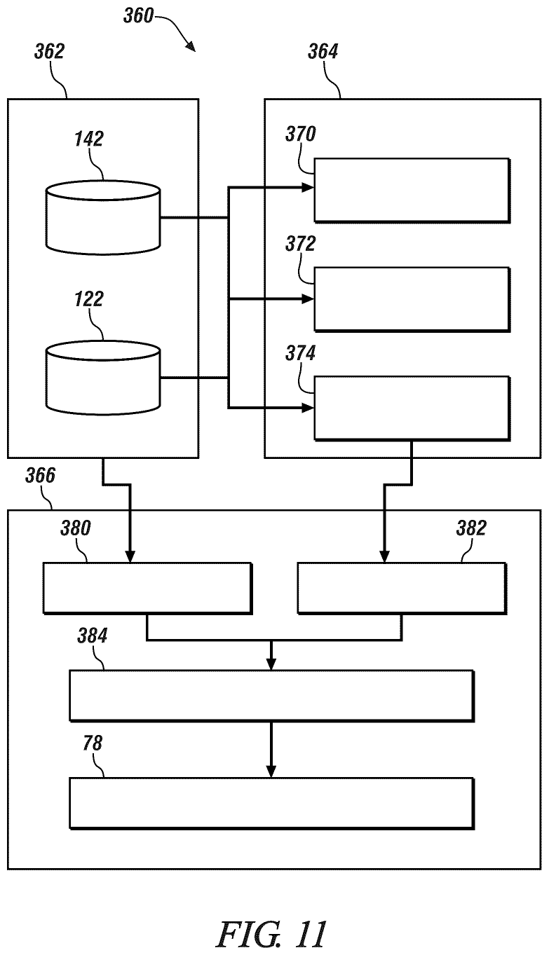

Referring to FIG. 11, with reference back to FIGS. 1 and 2, a schematic diagram of an example sensor fusion neural network is shown in accordance with one or more exemplary embodiments. The sensor fusion neural network 360 generally includes a local features block 362, a sensor-fusion features block 364, and a neural network 366. The local features block 362 includes the TOA sensors 122 and the AOA sensors 142. The sensor-fusion features block 364 includes a signal consistency block 370, an AOA valid range verification block 372, and a communication delay block 374. The neural network 366 includes an identical subnet 38, a differential subnet 382, and a multi-attention transformer encoder 384. The multi-attention transformer encoder 384 produces the location 78 in three dimensions. In various embodiments, the local features block 362, the sensor-fusion block 364, and the neural network 366, may be implemented in the processing circuit 104.

The sensor fusion neural network 360 is operational to isolate measurement noises caused by dynamic noises from a subset of the sensors 122 and 142 in a wireless sensor network. By utilizing a Siamese neural network architecture and a multi-attention model, a few (e.g., two) of the sensor sets 122 and 142 may be implemented while demonstrating an adaptability to various noise patterns. The Siamese neural network generally uses the same weights while working in tandem on two different input vectors to compute comparable output vectors.

The multi-attention model considers data from both the localization features block 362 and the sensor-fusion features block 364. The network processes direct time-of-arrival and angle-of-arrival measurements using the Siamese neural network, while also emphasizing performance variances across the sensors 122 and 142 by integrating additional features. Both the direct features and the additional features may be systematically processed by the sensor fusion neural network 360 to cooperatively locate the transmitter 74 in the three-dimensional volume 64.

Direct features. The TOA measurements are used to estimate the distance D between the transmitter 74 and the receivers 122. Assuming the speed of light c and the time difference δt between the transmission and reception of the signal 76 in a round trip, a distance D is given by equation 19 as follows:

$$D = ( c \times δ t ) / 2 \qquad Eq . ( 19 )$$

Furthermore, the antenna arrays in the AOA sensors 142 may be used to measure the arrival angle of incoming signals 76. By comparing the phase differences of signals 76 received by different elements of the antenna array, both the azimuth and elevation angle of arrival may be estimated. Assuming d is the distance between elements of the antenna array and γ is the wavelength of the signal 74, a phase difference ΔΘ between two adjacent antennas may be related to the angle of arrival (AoA) per equation 20 as follows:

$$A o A = arcsin ( ΔΘ \times γ ) / ( 2 π \times D ) \qquad Eq . ( 20 )$$

The sensor-fusion features block 364 may consider additional features including the angle of arrival range validation, signal communication delay, and temporal signal consistency. Since the angle of arrival is calculated by analyzing the phase differences between signal 74 received at different antennas, such measurements may be considered less accurate than the time of arrival measurements.

A verification approach may be implemented to detect the unreliable angle of arrival data based on a pair of time of arrival measurements. Based on the spherical geometry (as shown in FIG. 2), the first sphere 126 and the second sphere 130 are drawn with respect to the mounting locations of the sensor anchors 102a-102b as centers and the time of arrival measurements as the radii. The intersection of the two spheres 126 and 130 forms the circle 134. The ratio between the radius of the circle 134 and the time of arrival measurement indicates whether the transmitter 73 is located within or outside the valid range.

Based on the above configuration, given a pair of anchor mounting at (xᵢ, yᵢ, zᵢ) and (zⱼ, yⱼ, zⱼ), where the accurate distance measurements are denoted as dᵢ and dⱼ, as provided by equations 11, 12, and 13, above. Then, whether the angle of arrival measurement from sensor j is reliable, a trustworthiness indicator αj may be defined per equation 21 as follows:

$${α}_{j} = arcsin ( \frac{\sqrt{{( {d}_{j} )}^{2} - {( x - {x}_{j} )}^{2}}}{{θ}_{j}} ) - {θ}_{j} \qquad Eq . ( 21 )$$

Thereafter, the block 372 may determine an AoA verification factor as Vⱼ, where Vⱼ=1 only if αⱼ<=0; otherwise, Vⱼ=0. This enables the sensor fusion neural network 360 to validate the angle of arrival data and avoid using out-of-view faulty measurements, resulting in more accurate hybrid localization by providing extra features as inputs to the neural network 366.

The block 374 may consider the signal communication delay and the temporal consistency of each signal 74 to provide valuable features. Due to the signal delay when tracking a moving object, measurements taken closer in time tend to be more accurate. Denote the communication delay of sensor j as δtj, thus a normalized delay factor λₖ of sensor j may defined by equation 22 as follows:

$${λ}_{k} = \frac{δ {t}_{j} - max ( δ t )}{max ( δ t ) - min ( δ t )} \qquad Eq . ( 22 )$$

Further define Cj to represent a temporal consistency in n consequential measurements that is estimated by a standard deviation to check if the signal 76 behaved in a predictable and stable manner over time. The temporal consistency may be determined by block 370 per equation 23 as follows:

$${C}_{j} = \frac{1}{\sqrt{\frac{1}{n} {\sum }_{k = 1}^{n} {( {x}_{t} - \hat{x} )}^{2}}} \qquad Eq . ( 23 )$$

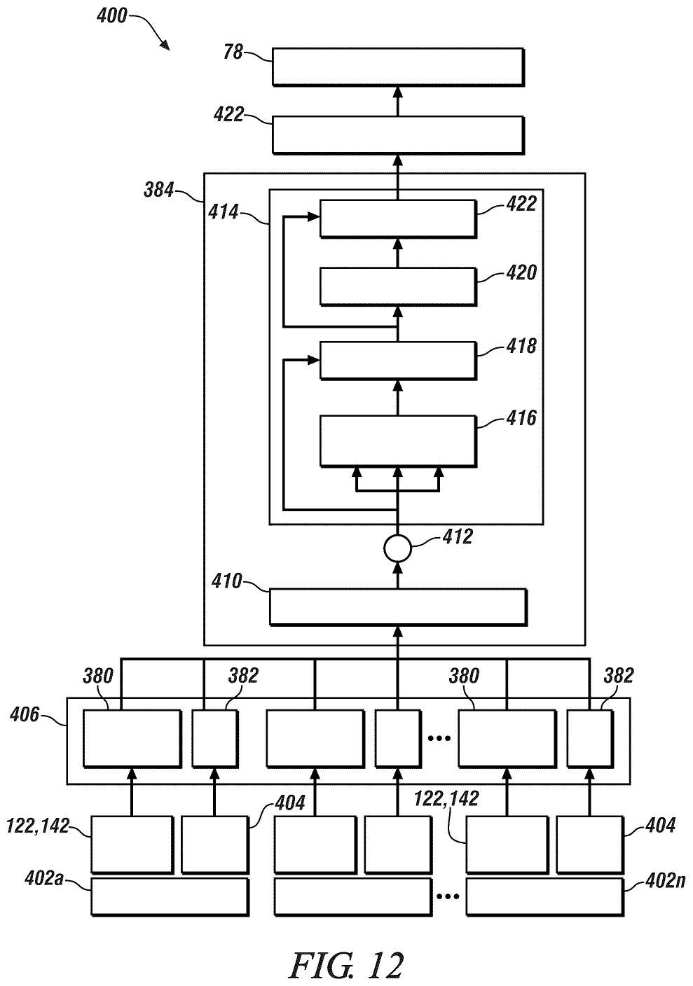

Referring to FIG. 12, with reference back to FIGS. 2 and 11, a schematic diagram of an example neural network architecture design is shown in accordance with one or more exemplary embodiment. The neural network architecture design 400 includes multiple sets of the sensors 122 and 124; multiple delay, out of view, standard blocks 404; a layer 406; the multi-attention transform encoder 384; and a feedforward block 422 that presents the locations 78 of the transmitters 74. The layer 406 may include multiple pairs of identical subnets 380 and differential subnets 382. Multiple input signals 402a-402n may be received by the multiple pairs of identical subnets 380 and differential subnets 382. The multi-attention transform encoder 384 generally includes a feature fusion and embedding block 410, a positional encoding block 412 and a network 414. The network 414 includes a multi-head attention block 416, a first add and normalize block 418, a feed forward block 420, and a second add and normalize block 422. In various embodiments, the multi-attention encoder 384, the layer 406, and the feed forward block 422 may be implemented in the processing circuit 104.

Sensor Fusion Neural Network. Utilizing multiple sensors generally benefits the localization system by extending a range and improving accuracy through redundancy. Formulating the noise model and balancing the contributions from different sensors may present challenges. Uncertain signal noise may arise from signal blockage, Gaussian noises, and signal reflections. Traditional least-squares triangulation and trigonometric functions may not accurately capture the relationship between the location of the transmitter 74 and sensor measurements under such conditions. Therefore, a machine learning model is provided that incorporates multiple time of arrival data, multiple angle of arrival data, the communication delays (λ), the signal temporal consistency (C), and the angle of arrival validation factors (V) as input features for location estimation.

The neural network architecture design 400 generally includes three sections: the identical sub-networks 380, the differential sub-network 382, and the sensor fusion features block 364. Based on the neural network architecture design 400, multiple (e.g., two) type of sensor fusion neural networks may be implemented, a semantic features function neural network (SFNN) and a Takagi-Sugeno fuzzy neural network (T-SFFN). In SFNN, the network is directly trained on real-time collected data. In contrast, T-SFNN employs a knowledge transfer mechanism, where the identical sub-networks share the same weights that are transferred from the single-sensor localization network. The weights are then frozen in the second stage of training during sensor fusion.

Identical Siamese Sub-Networks. Assuming that each sensor follows the same logic in location estimation within a self-coordinate system, identical sub-networks may be used to represent the logic of single sensor localization. Based on the Siamese network structure where the sub-networks share the same weights and architecture, the identical sub-networks are built on top of each single sensor where each local input time of arrival and angle of arrival features are processed in the same way.

The single-sensor localization neural network model, which consists of multiple (e.g., two) layers of interconnected neurons, learns to map the input features (e.g., time of arrival data and angle of arrival data) to an estimated position of a transmitter 74. The weights from the internal layers are initially trained and subsequently transferred across the different sensors in the T-SFNN model.

Differential Sub-Network: The component emphasizes performance differences across multiple sensors. Although the data from each sensor is processed through shared layers of the Siamese network to extract meaningful features, there is no guarantee that the sensors share an identical performance. The performance variance in sensor fusion may be contributed from the following three factors. Since the target may be located in regions outside the valid angle of arrival range for a subgroup of sensors (as illustrated in FIG. 10), the trustworthiness (α) among sensors varies where the sensor may be intended to cover a broad (e.g., 180 degree) range, however, the sensor reliably captures accurate measurements within a narrower (e.g., 120 degree) span. In a unicast time-weighted return (TWR) model, the communication delay (δt) also plays a role in emphasizing or reducing the contribution from certain sensors, especially when localizing a moving object. Additionally, temporal signal consistency (C) indicates whether some sensors are experiencing more difficulties than others in providing accurate measurements in a noisy environment.

The differential sub-network 404 may consider the above features as input to generate an additional feature map for each sensor in localization. Although the sub-networks share the same structure, the weight parameters may be updated in the second training stage.

The multi-attention encoder 384 is built on top of multiple identical and differential networks in layer 406. The multi-attention encoder 384 may be connected with the feed forward network 422 to provide accurate three-dimensional coordinates in sensor fusion. The sub-network extracts deep features from both the identical subnet 380 and the differential subnet 382 of each sensor. The positional encoder 412 aid in distinguishing the features based on positions/orders respecting to the sensors, thus captures dependencies across the feature list. (e.g., ToA of sensor #1 may have a stronger dependency to both ToAs provided by other sensors and the AoA provided by the same sensor, but is less likely to be relevant to the out-of-view AoA provided by the sensor #2). On top of the positional encoding, the multiple attention heads 416 operates in parallel, allowing the model to jointly attend to information from different representation sub-spaces at different positions. The feed-forward and normalization layers 418, 420 and 422 are added to further learn the sensor fusion logic and accelerate convergence.

By leveraging attention mechanisms, the encoder 384 may focus on more reliable sensor measurements while diminishing the impact of noisy or faulty data. The encoder 384 dynamically adjusts the weight of the contributions of each sensor based on real-time data quality and consistency, that refines the estimation of the location 78 even in complex scenarios where some sensors are out of the valid angle of arrival range.

A hybrid TOA and AOA architecture is provided that minimize a number of sensors (less dependencies and faster localization). By combining the TOA and AOA, the system may rely on as few as one sensor anchor, which results in much more efficient and faster localization. A time-dependent weighted LLS method is designed to improve the accuracy on localizing the moving transmitter. The method considers both anchor sensors trustworthiness and the communication latency for designing the weighted matrix. A two-stage localization technique that balances the contribution between TOA and AOA generally improves the accuracy. The first stage uses TOA to categorize and filter out the inaccurate measurements. The second stage uses the TOA and AOA together to determine the final location.

Various embodiments of the system generally enable a variety of occupant facing applications (e.g., location-based personalization and automation). The system may be light-weight and efficient to implement on embedded processors while locating the transmitters in the three-dimensional space. In various embodiments, the number of anchor sensors are reduced. Multiple antennas in the modern sensors provide both distance and angle measurements, that reduces the number of anchor sensors. The fewer anchor sensors also reduce the hardware and system complexity, and improve localization efficiency.

The system provides a hybrid TOA and AOA approach that minimizes the number of sensors resulting in less dependencies. A time-dependent weighted LLS method is implemented to improve the accuracy on localizing of moving transmitters. The two-stage localization technique balances the contribution between TOA and AOA to improve the overall accuracy.

Embodiments of the disclosure generally provide a system that includes a plurality of angle-of-arrival receivers, a plurality of time-of-arrival receivers, and a processing circuit. The angle-of-arrival receivers are operational to measure a plurality of directions between a transmitter and the angle-of-arrival receivers. The transmitter is movable within a volume. The time-of-arrival receivers are operational to measure a plurality of distances between the transmitter and the time-of-arrival receivers. The processing circuit is coupled to the angle-of-arrival receivers and the time-of-arrival receivers. The processing circuit is operational to determine a location of the transmitter in three dimensions within the volume based on the directions and the distances, and report the location of the transmitter to additional circuitry.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A system comprising:
a plurality of angle-of-arrival receivers operational to measure a plurality of directions between a transmitter and the plurality of angle-of-arrival receivers, wherein the transmitter moves within a volume;
a plurality of time-of-arrival receivers operational to measure a plurality of distances between the transmitter and the plurality of time-of-arrival receivers; and
a processing circuit coupled to the plurality of angle-of-arrival receivers and the plurality of time-of-arrival receivers, wherein the processing circuit is operational to:
determine a location of the transmitter in three dimensions within the volume based on the plurality of directions and the plurality of distances; and
report the location of the transmitter to additional circuitry.

2. The system according to claim 1, wherein to determine the location of the transmitter the processing circuit is further operational to:
perform a time-dependent weighted linear least squares operation on the plurality of directions and the plurality of distances.

3. The system according to claim 2, wherein the time-dependent weighted linear least squares operation includes:
a trustworthiness analysis on a plurality of sequential measurements of the plurality of directions and the plurality of distances.

4. The system according to claim 3, wherein the trustworthiness analysis includes:
a spatial consistency analysis that determines a plurality of deviations of the plurality of sequential measurements from a global estimate;
a temporal consistency analysis that calculates a plurality of standard deviations of the plurality of sequential measurements over time; and
determine a consistency based on the plurality of deviations and the plurality of standard deviations.

5. The system according to claim 4, wherein the time-dependent weighted linear least squares operation includes:
calculate a plurality of weights in response to a plurality of measurement times, a plurality of localization timestamps, and the consistency; and
construction of a weighted matrix based on the plurality of weights.

6. The system according to claim 1, wherein to determine the location of the transmitter, the processing circuit is further operational to:
perform a two-stage localization operation on the plurality of directions and the plurality of distances.

7. The system according to claim 6, wherein a first stage of the two-stage localization operation includes:
determine a plurality of pseudo locations of the transmitter within the volume based on the plurality of distances.

8. The system according to claim 7, wherein a second stage of the two-stage localization operation includes:
determine one of the plurality of pseudo locations as the location of the transmitter based on the plurality of directions.

9. The system according to claim 8, wherein the second stage of the two-stage localization operation includes:
remove one or more out-of-view pseudo locations of the plurality of pseudo locations that is hidden from one or more of the plurality of angle-of-arrival receivers prior to the determination of the location.

10. The system according to claim 1, wherein:
the transmitter is a mobile phone operational to transmit a signal detectable by the plurality of angle-of-arrival receivers and the plurality of time-of-arrival receivers.

11. A method for three-dimensional tracking of a transmitter within a volume comprising:
measuring a plurality of directions between the transmitter and a plurality of angle-of-arrival receivers, wherein the transmitter moves within the volume;
measuring a plurality of distances between the transmitter and a plurality of time-of-arrival receivers;
determining with a processing circuit a location of the transmitter in three dimensions within the volume based on the plurality of directions and the plurality of distances; and
reporting the location of the transmitter from the processing circuit to additional circuitry.

12. The method according to claim 11, wherein the determination of the location of the transmitter includes:
performing a time-dependent weighted linear least squares operation on the plurality of directions and the plurality of distances.

13. The method according to claim 12, wherein the time-dependent weighted linear least squares operation includes:
analyzing a trustworthiness on a plurality of sequential measurements of the plurality of directions and the plurality of distances.

14. The method according to claim 13, wherein the analyzing of the trustworthiness includes:
analyzing a spatial consistency that determines a plurality of deviations of the plurality of sequential measurements from a global estimate;
analyzing a temporal consistency that calculates a plurality of standard deviations of the plurality of sequential measurements over time; and
determining a consistency based on the plurality of deviations and the plurality of standard deviations.

15. The method according to claim 14, wherein the time-dependent weighted linear least squares operation includes:
calculating a plurality of weights in response to a plurality of measurement times, a plurality of localization timestamps, and the consistency; and
constructing of a weighted matrix based on the plurality of weights.

16. The method according to claim 11, wherein the determining of the location of the transmitter includes:
performing a two-stage localization operation on the plurality of directions and the plurality of distances.

17. The method according to claim 16, wherein a first stage of the two-stage localization operation includes:
determining a plurality of pseudo locations of the transmitter within the volume based on the plurality of distances.

18. The method according to claim 17, wherein a second stage of the two-stage localization operation includes:
determining one of the plurality of pseudo locations as the location of the transmitter based on the plurality of directions.

19. The method according to claim 18, wherein the second stage of the two-stage localization operation includes:
removing one or more out-of-view pseudo locations of the plurality of pseudo locations that is hidden from one or more of the plurality of angle-of-arrival receivers prior to the determination of the location.

20. A vehicle comprising:
a cabin that defines a volume, wherein the volume is sized to hold one or more occupants and a transmitter, and the one or more occupants are operational to move the transmitter within the volume;
a plurality of angle-of-arrival receivers disposed in the cabin and operational to measure a plurality of directions between the transmitter and the plurality of angle-of-arrival receivers;
a plurality of time-of-arrival receivers disposed in the cabin and operational to measure a plurality of distances between the transmitter and the plurality of time-of-arrival receivers; and
a processing circuit coupled to the plurality of angle-of-arrival receivers and the plurality of time-of-arrival receivers, wherein the processing circuit is operational to:
determine a location of the transmitter in three dimensions within the volume based on the plurality of directions and the plurality of distances; and
report the location of the transmitter to additional circuitry.
